(19) United States
(12) Patent Application Publication
(10) Pub. No.: US 2014/0156552 A1
(43) Pub. Date: Jun. 5, 2014

(54) CONSTRUCTION CONTAINER

(71) Applicant: Fred Garfinkel, Newton, NJ (US)

(72) Inventor: Fred Garfinkel, Newton, NJ (US)

(21) Appl. No.: 14/092,140

(22) Filed: Nov. 27, 2013

Related U.S. Application Data
(60) Provisional application No. 61/730,390, filed on Nov. 27, 2012.

(51) Int. Cl. G06Q 10/08; B65D 88/58

(52) U.S. Cl. CPC G06Q 10/083; B65D 88/58
USPC 705/330; 220/4.28

(57) ABSTRACT

The present disclosure relates to a reusable container, and specifically, a dual service reusable container. The containers may be prepositioned at a particular location until the items stored within the container are needed. This is possible because the dual service reusable containers may be both weather resistant and lockable. The containers are designed to be stackable when loaded, reducing the footprint occupied by the containers, improving shipping efficiency, and improving the utilization of the valuable floor space. When unloaded or when partially loaded, the containers may be nested so that valuable floor space is efficiently used.

### CROSS REFERENCE To RELATED APPLICATIONS

The present application claims the benefit of U.S. Provisional Application No. 61/730,390, filed on Nov. 27, 2012. The entire contents of U.S. Provisional Application No. 61/730,390 are hereby incorporated herein by reference in their entirety.

### TECHNICAL FIELD

The present disclosure relates to a reusable container, and specifically, a dual service reusable container.

### BACKGROUND

Conventional containers are made of cardboard or similar materials. Although affordable, conventional containers are not secure because they can easily be opened by others by simply cutting or otherwise piercing the container. Conventional containers are not also weather proof. One common method of protecting conventional containers requires the use of shrink wrap. Another method of protecting conventional containers uses an enclosed storage facility like a warehouse. Conventional containers also cannot support other containers with large loads. This causes excess amounts of valuable floor space to be consumed in a storage facility. Conventional containers are also not easily moved without the addition of pallets or wheeled mechanisms like carts. Conventional containers are often times only delivered to the curbside of a location because the delivery vehicle cannot deliver the container to a more suitable location without damaging the location. Embodiments of the dual service reusable containers described here may solve some or all of these and other problems. Two common situations where these and other advantages of the dual service reusable containers are exemplified are at a construction work site and at a retailer.

When the dual service reusable containers are used on a construction work site, the containers may be prepositioned on the site until the items stored within the container are needed. This is possible because the dual service reusable containers may be both weather resistant and lockable. After the contents of the containers are removed, the container may remain at the work site so that construction debris and other waste items may be loaded. If necessary, the container may again be secured so that the debris is protected from the elements and from others. The container can then be collected and emptied in accordance with applicable disposal regulations. The container may then be cleaned and reused.

When the dual service reusable containers are used by retailers, other features of the containers become apparent. The containers are designed to be stackable when loaded. This feature reduces the footprint occupied by the containers, improves shipping efficiency, and improves the utilization of the valuable floor space. When unloaded or when partially loaded, the containers may be nested so that valuable floor space is efficiently used. Costs can also be reduced because there may be no need to use shrink wrap or pallets. Costs can be further reduced because the containers may be weather resistant and secured, allowing for the containers to be stored outside or in other less secure locations.

These advantages and other features of the dual service reusable containers will be described in detail in the following disclosure.

### SUMMARY

One aspect of the present disclosure is directed to a container useful as a dual service reusable container, the container comprising a bottom panel, a top cover disposed substantially parallel to the bottom panel, a first side panel disposed between a first transverse side of the bottom panel and a first transverse side of the top cover, a second side panel disposed between a second transverse side of the bottom panel and a first transverse side of the top cover, a first end panel disposed between a first longitudinal side of the bottom panel and a first longitudinal side of the top cover, and a second end panel disposed between a second longitudinal side of the bottom panel and a second longitudinal side of the top cover, wherein the two end panels, the two side panels, the bottom panel, and the top cover define a container body that includes an interior volume of the container, wherein the two end panels and the bottom panel are joined to form a fixed structure, wherein the top cover is removable from the fixed structure to facilitate loading or unloading of the container, wherein at least one of the side panels is removable from the fixed structure to facilitate loading or unloading of the container.

Another aspect of the present disclosure is directed to a system comprising the dual service reusable container at least one load bar adapted to be placed on the top cover in order to stack a similar container on top of the container.

A further aspect of the present disclosure is directed to a method of delivering goods to a location using the dual service reusable container including a delivery provider delivering the container containing items from a sender sending location to a recipient receiving location, the recipient removing items from the container, the delivery provider delivering the container from a recipient sending location to a sender receiving location.

### BRIEF DESCRIPTION OF THE DRAWING FIGURES

FIG. 1 depicts the box cover for one embodiment of the dual service reusable container in both a top view and a side view.

FIG. 2 depicts the top view of the box cover installed on the dual service reusable container and illustrates the turning radius of the container.

FIG. 3 depicts an end view of one embodiment of the dual service reusable container and a magnified view of the top edges of the sides of the dual service reusable container.

FIG. 4 depicts a side elevation view of the dual service reusable container.

FIG. 5 depicts the box cover for another embodiment of the dual service reusable container in both a top view and a side view.

FIG. 6 depicts the top view of the box cover and a removable side panel for the embodiment shown in FIG. 5.

FIG. 7 depicts an end view of the embodiment shown in FIG. 5 and a magnified view of the top edges of the embodiment.

FIG. 8 depicts a side elevation view of the dual service reusable container depicted in FIG. 5.

FIG. 9a depicts conventional shipping methods.

FIG. 9b depicts a plurality of dual service reusable containers arranged in a shipping trailer.

FIG. 10 depicts a typical shipping method for use with the dual service reusable containers.

FIG. 11 depicts a modified embodiment of the dual service reusable container.

FIG. 12 depicts an exploded view of the various components of the modified embodiment of the dual service reusable container.

FIG. 13 depicts the top and bottom of the bottom panel of the modified embodiment of the dual service reusable container.

FIG. 14 depicts the top cover of the modified embodiment of the dual service reusable container.

FIG. 15 depicts a cross section of the corner post of the modified embodiment of the dual service reusable container.

FIG. 16 depicts the interlocking panels of the modified embodiment of the dual service reusable container.

FIG. 17 depicts one embodiment of the removable panel of the modified embodiment of the dual service reusable container in conjunction with two corner posts, the removable channel, and the bottom panel.

FIG. 18 depicts a cross-section of the embodiment of the removable panel with the removable channel and the bottom panel.

FIG. 19 depicts a top view of the modified embodiment of the container.

### DETAILED DESCRIPTION

The dual service reusable container 10 is a component of a reusable shipping/waste removal system. The dual service reusable container 10 includes a container body formed by two side panels 20, two end panels 30, and a bottom panel 40. At least one side panel 20 is removable. These panels cooperate to form the container body and define an interior container volume and an open container top. A removable top cover 50 can be attached to cover the container body and seal the interior container volume.

The bottom panel 40 provides a structure to which the end panels 30, lift pockets 41, removable outriggers 42, and wheels 43 may be attached. The bottom panel 40 also provides a structure to which the at least one removable side panel 20, described later, can be attached.

The end panels 30 of the container 10 and the bottom panel 40 of the container form a fixed structure of the container 10. The end panels 30 are placed on opposite sides of the bottom panel 40. In other words, a first end panel 30 is disposed between a first longitudinal side of the bottom panel 40 and a first longitudinal side of the top cover 50, and a second end panel 30 is disposed between a second longitudinal side of the bottom panel 40 and a second longitudinal side of the top cover 50. The fixed structure defined by the opposing end panels 30 and the bottom panel 40 of the container 10 provides the structure to which removable portions are attached. The surfaces defined by the end panels 30 and the bottom panel 40 may be joined so that the surfaces are flush with one another. In another embodiment, the surfaces of the end panel 30 may be inwardly offset from the edge of the bottom panel 40 so that the inward offset defines a lip.

The components of the fixed structure are fixed to each other in a structurally resilient manner. The term “fixed” is defined as “held in place in a structurally resilient manner.” In some embodiments, a non-removable side panel 20 is included opposite a removable side panel 20. In these embodiments, the non-removable side panel 20 is also a component of the fixed structure. The components of the fixed structure may be integrally formed in a single unitary piece. In other words, the components of the fixed structure are continuous with each other. In another embodiment, the components of the fixed structure are permanently affixed to each other after assembly. In a further embodiment, the components of the fixed structure are reversibly affixed to each other so that the fixed structure can be disassembled at a later time.

Removable portions combine with the fixed structure of the container 10 to define the interior container volume. The term “removable” is defined as “fully detachable from the fixed structure.” The removable portions are joined with the fixed structure of the container 10. The removable portions may include surfaces that correspond to gaps, grooves, channels, or other surfaces in the fixed structure of the container 10. The surfaces of the removable portions that correspond to gaps, grooves, channels, or other surfaces on the fixed structure of the container 10 may be of any shape or configuration that provides rigidity to the container body. The removable panels and the corresponding panels in the fixed structure of the container 10 may be formed in a continuous manner along the entire perimeter of the container 10. In another embodiment, the removable panels and corresponding panels in the fixed structure of the container 10 may be arranged in a discontinuous manner. In an embodiment, the removable portions are completely separable from the fixed structure of the container 10. In other words, the removable portions of the container 10 are attachable and detachable from the fixed structure of the container 10.

The ability to completely detach the removable portions of the container 10 from the fixed structure helps reduce the possibility of damaging any structures that link the removable portions from the fixed structure of the container 10. This configuration also improves access to the interior container volume and allows for efficient loading and unloading of the container 10. For example, the side panel 20 may be removed so that there is no lip on the bottom panel 40 and materials can be slid into the container 10 from an equal height counter surface.

The removable portions of the container 10 may each be formed in one or more segments, depending on the size of the container and other factors. For example, one factor may be a maximum weight threshold for an individual piece of the container. If a removable portion of the container would exceed a maximum weight if formed in a single piece, the removable portion may be divided into multiple segments. Each of the multiple segments may be configured so their individual weight does not exceed the maximum weight threshold.

In one embodiment of the dual service reusable container 10, the surfaces of the fixed structure that correspond to surfaces of the removable portions may collect water or other liquids. Drain ports may be added to allow water or other liquids to exit from the surfaces of the fixed structure to help prevent the contents contained in the interior container volume from being harmed by the liquids. The drain ports also help ensure a proper seal is formed between the removable portion and the corresponding surface of the fixed structure by removing any liquids that may have collected.

The side panels 20, when combined with the fixed structure, form the container body. At least one of the side panels 20 is a removable portion of the container 10. In an exemplary embodiment, both of the side panels 20 are removable portions of the container 10. The removable side panels 20 will be described in detail later. The side panels 20 are placed on opposite sides of the bottom panel 40. In other words, a first side panel 20 is disposed between a first transverse side of a bottom panel 40 and a first transverse side of a top panel 50, and a second side panel 20 is disposed between a second transverse side of a bottom panel 40 and a second transverse side of a top panel 50. Embodiments that only include one removable side panel 20 have an opposite non-removable side panel 20. In these embodiments, the non-removable side panel 20 may be combined with the end panels 30 and the bottom panel 40 to form the fixed structure. The non-removable side panel 20 may be placed so that the surface defined by the non-removable side panel 20 is flush with the bottom panel 40. In another embodiment, the surface defined by the non-removable side panel 20 may be inwardly offset from the edge of the bottom panel 40 so that the inward offset defines a lip.

The removable portions of the container 10 also include at least one of the side panels 20. A removable side panel 20 helps facilitate unloading and loading of the container 10. In one embodiment, the removable side panel 20 provides sufficient access to the container 10 so that items may be placed onto a planar surface, like a sheet of plywood. The contents can then be easily unloaded and loaded from the container 10 by simply sliding the planar surface out of and into the container 10. The removable side panel 20 may include the entire side surface of the container 10 or a portion of the entire side surface of the container 10. In an embodiment, both side panels 20 are removable. In another embodiment, the removable side panel 20 may comprise multiple segments so that each segment does not exceed a maximum weight threshold.

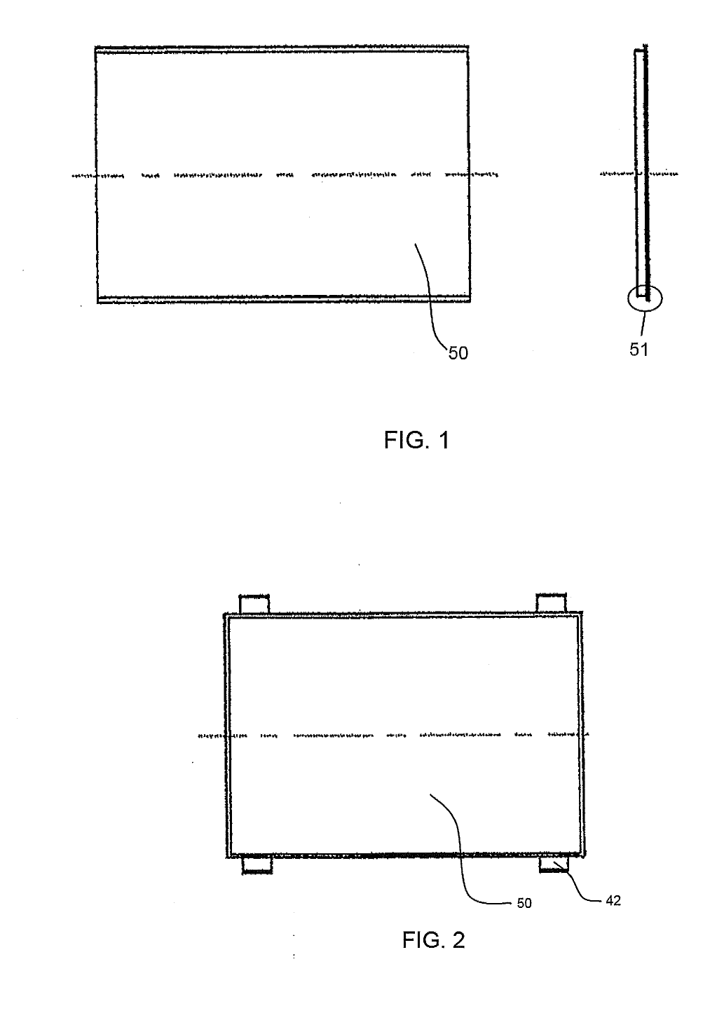

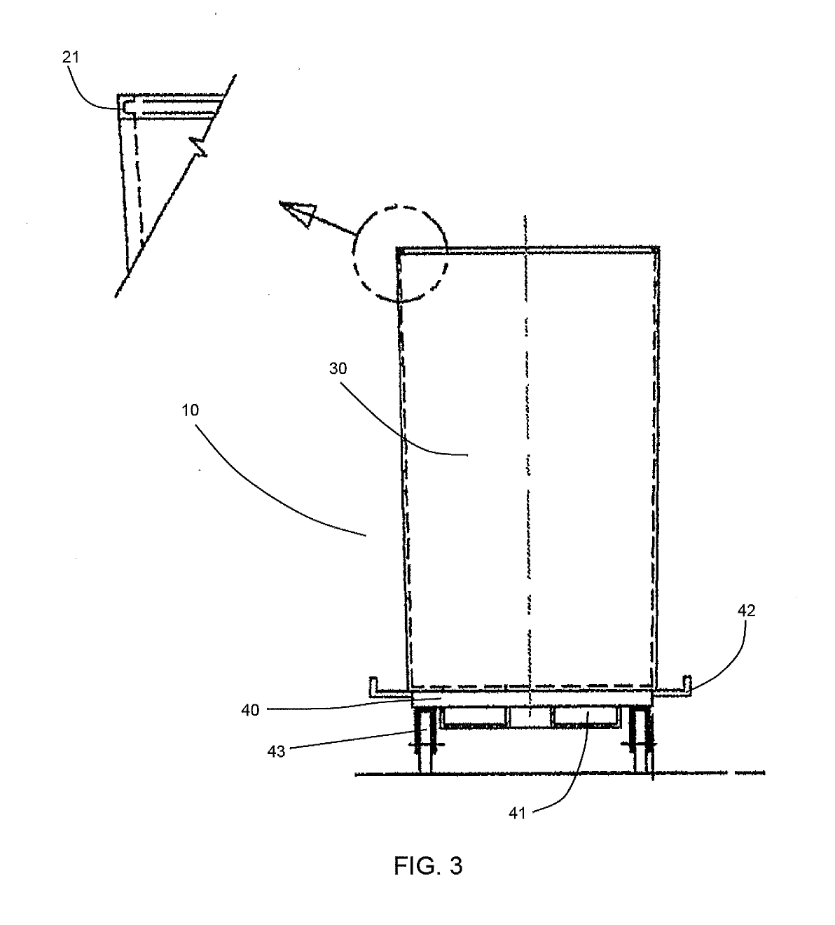

Another removable portion is the top cover 50. When the removable top cover 50 is combined with the container body, the interior container volume can enclose the contents of the container 10 in a weather resistant and secure manner. The enclosed interior container volume defined by the container body and the removable top cover 50 can be secured by a single lock portion. FIG. 1 depicts one embodiment of the top cover 50 that includes two side projections. These side projections 51 may be surfaces that correspond to channels 21, illustrated in FIG. 3, formed at an upper perimeter of the container body. The side projections 51 of the top cover 50 and the corresponding channels 21 of the container body cooperate to allow the top cover 50 of the container 10 to be completely removable to facilitate unloading and loading, while also providing enough structural support to support stacking of additional containers. The embodiment of the top cover 50 depicted in FIG. 1 has a flat outer surface. This flat outer surface allows the container 10 to serve as a means of transporting other items placed, for example, on the top cover 50.

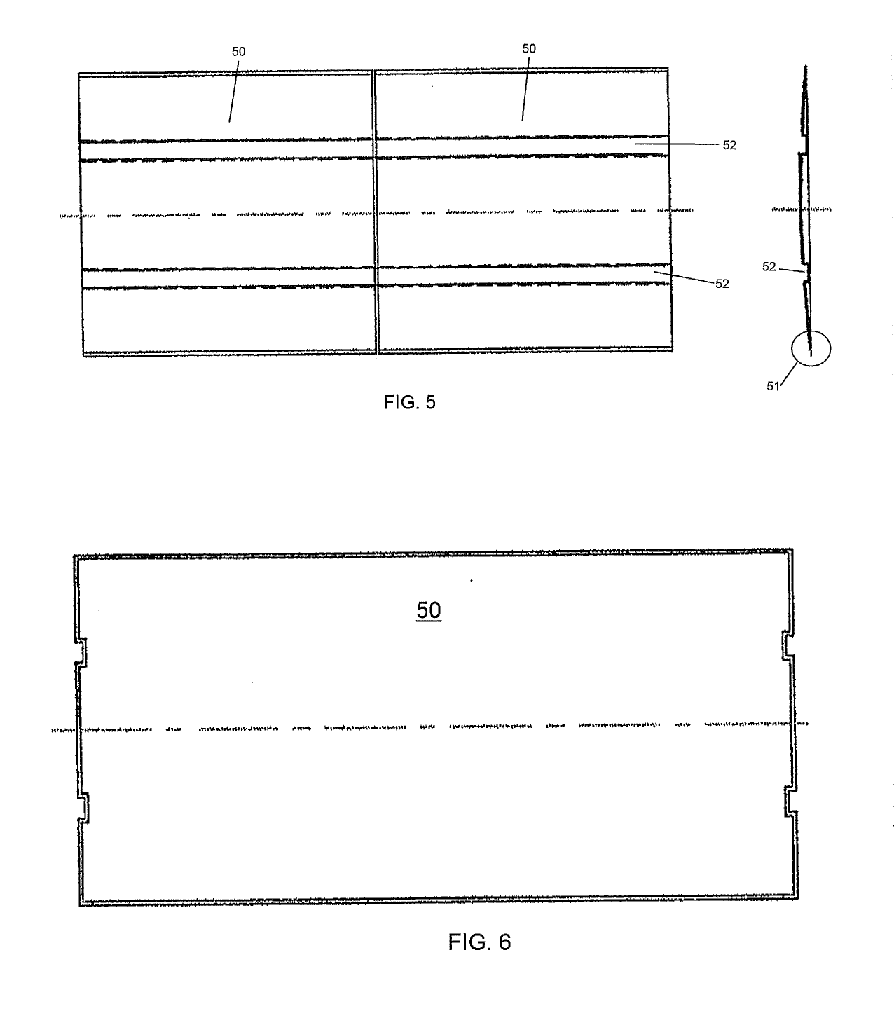

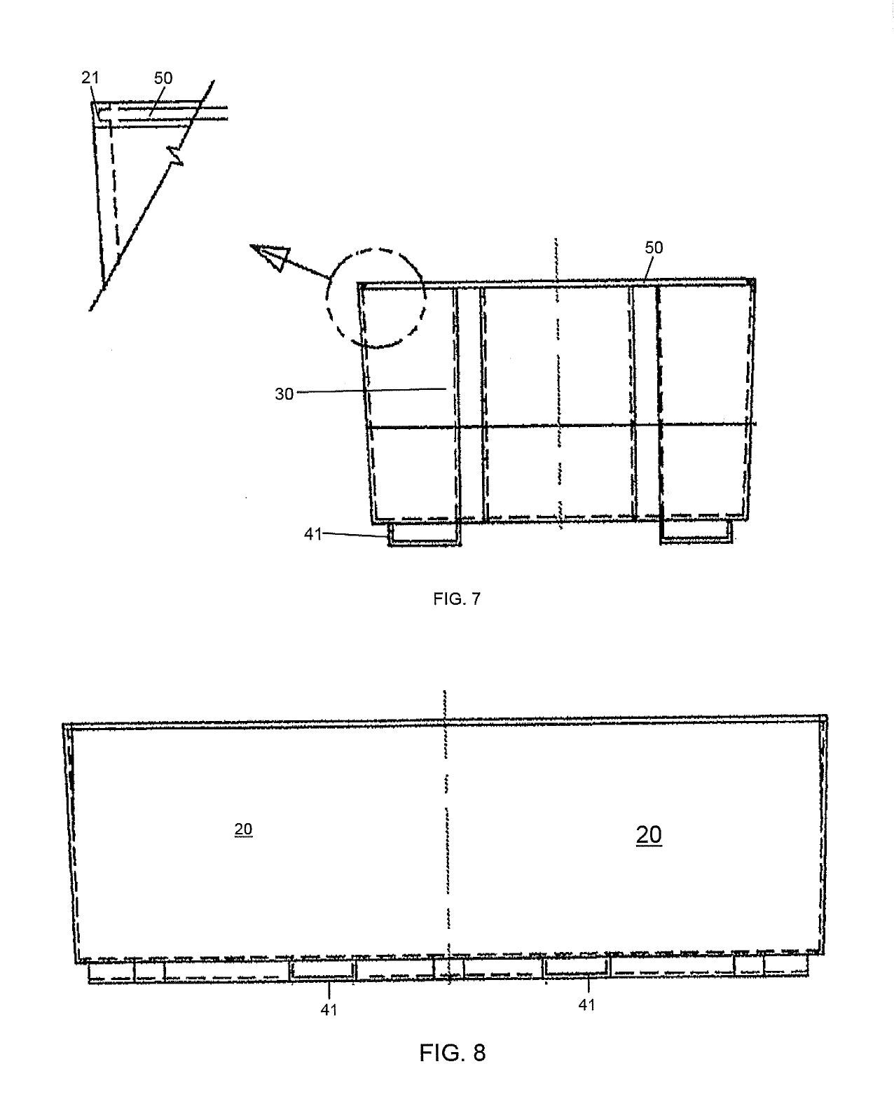

FIG. 5 depicts another embodiment of the top cover 50 that tapers from a widest middle portion to thinner side portions. This taper is adapted to help improve the weather resistance of the container 10 by preventing water from collecting on the top surface of the container 10. The tapered endmost portions 51 correspond to channels 21, shown in FIG. 7, formed at an upper perimeter of the container body. The tapered endmost portions 51 of the top cover 50 and the channels 21 of the upper perimeter of the container body cooperate to allow the top cover 50 of the container 10 to be removable to facilitate unloading and loading, while also providing enough structural support to support stacking of additional containers. In an embodiment, the top cover 50 may also rest partially or completely on the top of the container body. The top cover 50 may also include notches 52 adapted for load bars, which will be described later. The use of load bars is not, however, limited to this embodiment.

The top panel 50 may include a single lock portion. The single lock portion secures the contents of the container. Embodiments of the top panel 50 that include multiple segments may be also secured by a single lock portion. At least one of the multiple segments of the top cover 50 may slide into a locking position. Other segments of the top cover 50 that do not include the lock are then slid into adjacent locking positions. Finally, the segment that includes the single lock portion is slid into a final locking position. The multiple segments form an interlocked surface that secures the contents of the container with only a single lock portion. This improves the usability of the container by using only one lock instead of multiple locks. This simplifies the unloading and loading process by eliminating the need to unlock multiple locks to access the contents of the container, while still keeping the contents of the container secure.

The dual service reusable container 10 may also include load bars to facilitate stacking of containers loaded to the maximum design weight. The container 10 may also include lift pockets 41 so that the container 10 may easily be hoisted and moved. Wheels 43 may be also included on the dual service reusable container 10 to facilitate movement. Removable outriggers 42 can also be used to secure additional items outside of the container 10.

Load bars may be placed on the top cover 50 of the container 10. The load bars help a container to support at least one other similar container placed on top of the container 10. The load bars may include surface features for securing other containers and prevent movement while stacked. The load bars may be easily attached and removed from the top cover 50. Any number of load bars may be placed on the top cover 50 and the load bars may be of any width suitable for stacking at least one additional dual service reusable container. The load bars may be distributed across the top cover 50 in any manner suitable for supporting the load of at least one fully loaded dual service reusable container 10. One example of the top cover 50 includes two load bars with a width of at least 24 inches. The load bars may extend the entire length of the removable top cover 50. Other embodiments may include load bars that are formed by multiple load bar segments. The load bar segments may be continuous or discontinuous.

In one embodiment, the load bars are adapted to fit in corresponding notches of the removable top cover 50. An example of this embodiment of a top cover 50 is depicted in FIG. 5. In another embodiment, the load bars include grooves that correspond to ridges on the top cover 50. When the load bar is placed on the top cover 50 of such an embodiment, the load bar grooves cooperate with the top cover ridges to help secure the placement of the load bars.

Lift pockets 41 may be located beneath the bottom panel 40 of the container 10. The lift pockets 41 may be sufficiently strong to support the mass of a fully loaded container, when the container 10 is held at any angle. In one embodiment, the lift pockets 41 are sufficiently strong to support a fully loaded dual service reusable container 10 when inverted so that the bottom panel 40 is oriented upward and the removable top cover 50 is oriented downward or removed. In this configuration, the reusable container 10 quickly empties the contents contained therein. The container 10 may have an arrangement of lift pockets 41 to allow for four-way entry into the container 10 so that a standard lifting device, like a forklift, may approach from any direction and securely hoist and move the container 10. In an embodiment, at least two lift pockets 41 may be accessible beneath each of the side panels 20 and end panels 30. In one embodiment, the bottom panel 40 is formed so that lift pockets 41 may be integrally formed components of the bottom panel 40. In another embodiment, the lift pockets 41 are separate structures that are attached to the bottom panel 40 in a manner that allows the lift pockets 41 to support a fully loaded dual service reusable container 10 when inverted. The lift pockets 41 may be positioned adjacent to each other so that when, for example, a forklift or mofit lifts the container 10, the lift pockets 41 receive the arms of the forklift. Stated differently, the adjacent lift pockets 41 extend inward from the outer edge of the bottom panel 40 in a parallel manner and the adjacent lift pockets 41 are spaced from each other so that the container may be manipulated and moved by a forklift, a mofit, or another device.

Wheels 43 may be located beneath the bottom panel 40 of the container 10. The wheels 43 may be located at the corners of the container 10 so that high maneuverability and a small turning radius may be achieved. The wheels 43 may be attached to the bottom panel 40 of the container 10 by way of casters or other structures known to those of ordinary skill in the art. In other embodiments, the wheels 43 may be attached to any other portion beneath the container 10. The wheels 43 may freely rotate in any direction so that the container 10 may be easily maneuvered.

Removable outriggers 42 may also be connected to the container 10. For example, the removable outriggers 42 may be located beneath the bottom panel 40 of the container 10. The outriggers 42 may extend outward past the side panels 20 of the container 10. The outriggers 42 may be suitable for carrying additional material. The outriggers 42 may be formed in any shape that can securely hold materials. In one embodiment depicted in FIG. 3, the outriggers 42 may be formed in an L-shape so that the additional material can be securely held on the outside of the container.

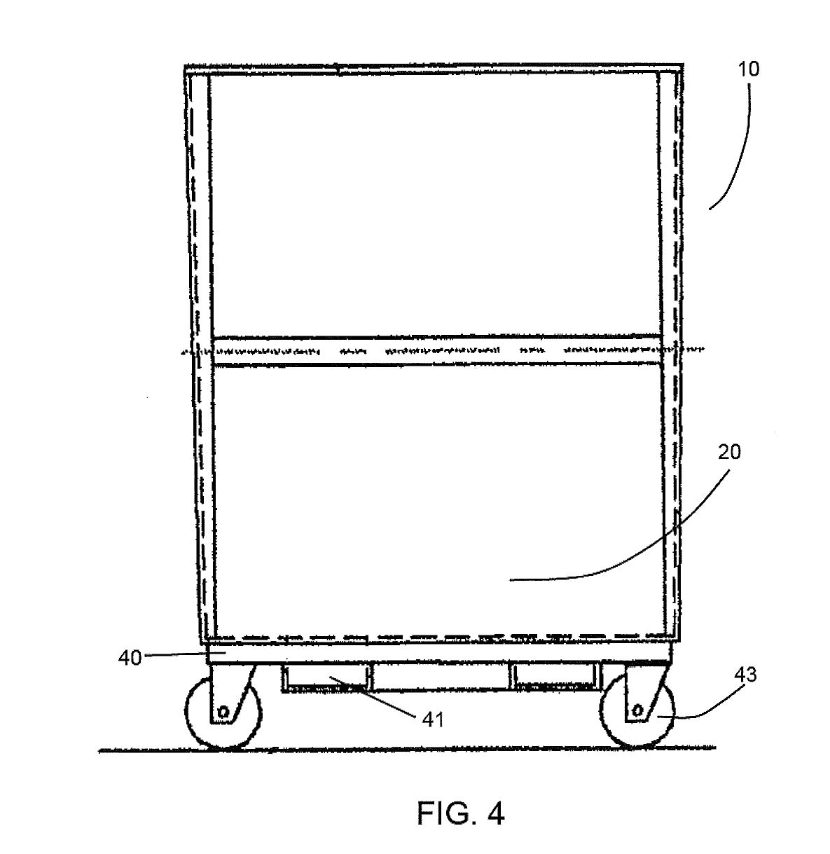

In one embodiment, depicted in FIGS. 3 and 4, the wheels 43 are attached to the container 10 by a plate, e.g., a metal plate, molded into the base of the container. The lift pockets 41 serve as mounting points for the outriggers 42. In another embodiment, depicted in FIGS. 7 and 8, the lift pockets 41 serve as mounting points both for the wheels 43 and the outriggers 42.

The dual service reusable container panels may be made of plastic, graphite composite, carbon fiber, or any other light weight and durable substance. The end panels 30, side panels 20, top cover 50, and bottom panel 40 may be formed using any suitable manufacturing technique well known to persons skilled in the art. The material used is sufficiently strong to secure the contents of the container 10 while the container 10 is locked. The material used is also water resistant and protects the contents of the container 10 from the weather even if the container 10 is placed in an outside storage facility. The material used is also sufficiently rigid to allow for stacking of multiple containers, even while fully loaded. This rigidity also allows the container 10 to maintain its shape and be unloaded and loaded without requiring the use of an additional rigid frame or other support structure. The material used is also easy to clean so that the container 10 can quickly be prepared for reuse. In one embodiment, high-density polyethylene is used to form the container 10.

The different panels of the dual service reusable container may be made of different materials. For example, the bottom panel 40 may be made of a material that differs from the rest of the container body so that additional structural support may be provided. In one embodiment, the bottom panel 40 is made of a molded metal piece so that extra structural support can be provided to the container body and so that the container 10 can support a high maximum design load.

The dual service reusable containers 10 may be manufactured in various colors so that the containers that correspond to a particular user or destination may be easily identified. The containers 10 may also be manufactured with stripes or other indicia to facilitate identification. The panels of the container may also contain depressed areas in the shape of a square, circle, or any other appropriate shape, so that decals or other identifying markers may be affixed for advertising or identification purposes.

The dimensions of several preferred embodiments of the dual service reusable container 10 will now be described in detail. The containers may be of a 1.5 cubic yard capacity, a 2 cubic yard capacity, a 3 cubic yard capacity, and a 4.5 cubic yard capacity. The outside width of the container may range from 20 to 200 inches, e.g., 27 to 108 inches, e.g., 27 to 54 inches, e.g., 46 to 54 inches or 30 to 38 inches. The outside length of the container may range from 20 to 200 inches, e.g., 40 to 108 inches, e.g., 40 to 54 inches or 96 to 108 inches. The height of the container may range from 20 to 108 inches, e.g., 28 to 36 inches or 66 to 74 inches. The outer dimensions of the container are configured to conform to the size limitations of standard shipping methods, such as one or two or three containers stacked or placed next to each other to reach the size limitations of standard shipping methods. For example, the container may be configured so that 21 containers may fit on a standard shipping method like a standard 32 foot flatbed trailer.

The 1.5 cubic yard and 2 cubic yard capacity containers are particularly suited for navigating narrow halls, small elevators, and through tight door openings that are commonly found in multi-family residential buildings. The 1.5 cubic yard and 2 cubic yard capacity containers can easily hold 4′×4′ sheets of plywood, sheetrock, or other materials. The outriggers of the container may hold larger items. The 1.5 cubic yard capacity container may hold up to 1,650 pounds of material. The 2 cubic yard capacity containers may hold up to 2,200 pounds of materials. Both the 1.5 cubic yard and 2 cubic yard capacity containers may be adapted to be stacked up to three dual service reusable containers high.

The 3 cubic yard and the 4.5 cubic yard containers are particularly suited for carrying full sized 4′×8′ sheets of plywood, sheetrock, or other materials. The outriggers of the container may hold larger items. The 3 cubic yard capacity container may hold up to 3,300 pounds of material. The 3 cubic yard capacity container may be adapted to be stacked up to three dual service reusable containers high. The 4.5 cubic yard container may hold up to 4,500 pounds of material. The 4.5 cubic yard container may be adapted to be stacked up to two dual service reusable containers high.

A variety of materials may be used to form the containers of the present disclosure. For example, in one embodiment, the container 10 is made of extruded aluminum with a thickness of between 1/16″ and ½″, e.g., between ¼″ and ⅛″. In another embodiment, the container 10 is made of a composite trunk plywood/fiberglass panel with a thickness of between ⅛″ and 1″, e.g., between ¼″ and ¾″. This composite panel may comprise a plywood core, a woven fiberglass roving, a pigmented resin, a melinex film, and a gelcoat. A further embodiment of the container 10 is made of pultruded fiberglass with a thickness between 1/10″ and 1.5″, e.g., between 1/10″ and 1″. Another embodiment is formed of twin sheet formed panels with a thickness between 1/16″ and ½″, e.g., between ⅛″ and ¼″.

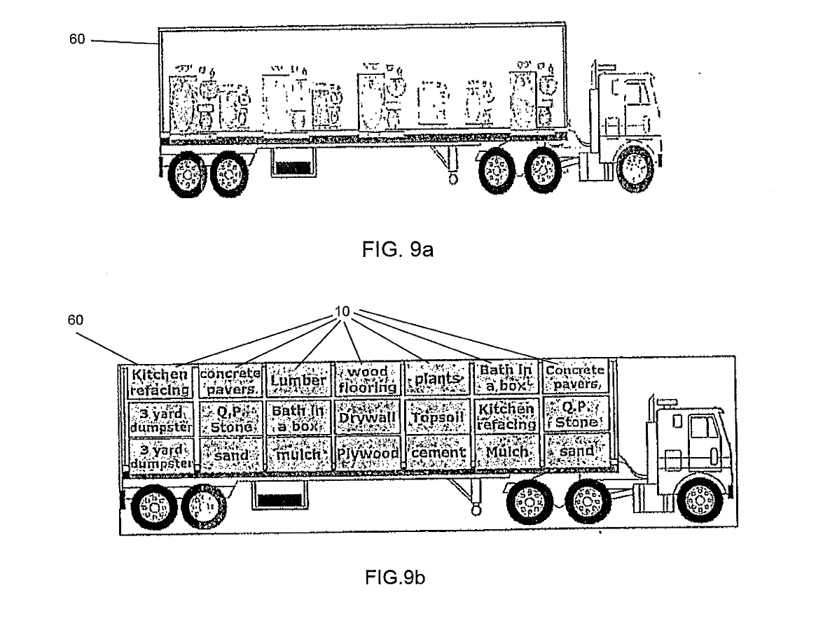

An example illustrating a plurality of dual service reusable containers placed in a standard shipping trailer 60 is illustrated in FIG. 9b. Multiple dual service reusable containers 10 may be stacked vertically in the standard shipping trailer 60. The vertical dimensions of each container 10 may be configured so that when the maximum number of dual service reusable containers 10 is stacked in the standard trailer 60, the majority of the vertical space of the standard trailer 60 is occupied. The maximum number of containers 10 that may be stacked varies depending on the particular embodiment of the container 10 being stacked. In a preferred embodiment, substantially all of the vertical space of the standard trailer 60 is occupied to maximize shipping efficiencies. The horizontal dimensions of each container 10 may be similarly configured so that the majority of the horizontal space of the standard trailer 60 is occupied when multiple dual service reusable containers are loaded. In a preferred embodiment, substantially all of the horizontal space of the standard trailer 60 is occupied to maximize shipping efficiencies. In an exemplary embodiment, the dual service reusable containers are dimensioned so that substantially all of both the vertical and horizontal space of a standard shipping container 60, like a trailer, a flatbed, or other common shipping method, will be occupied by properly arranged dual service reusable containers 10.

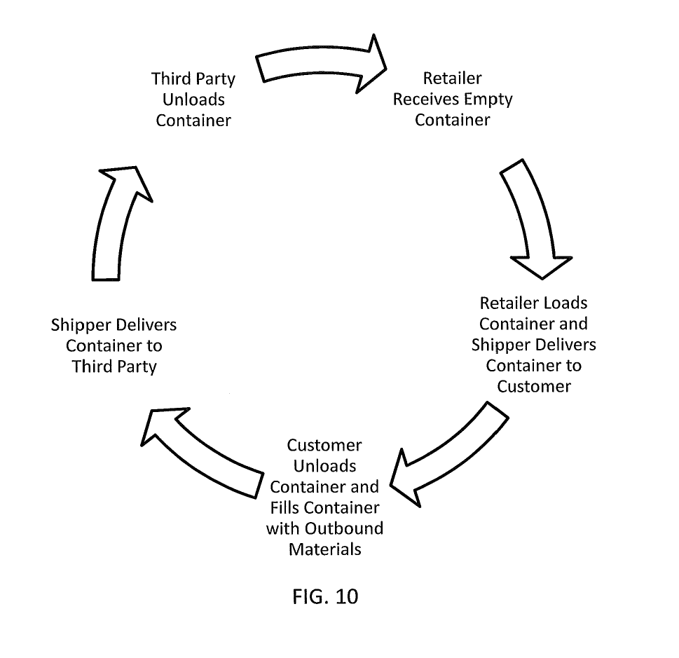

The use of the dual service reusable container on a construction site will now be described with respect to FIG. 10. The container is delivered to a construction site containing construction materials purchased from a retailer. The container may be placed in an unprotected area that is exposed to the weather until the contents of the container are needed because the contents are protected from the elements by the container. The unprotected area can be any area that is accessible by a standard lift device, like a fork lift. This helps facilitate the unloading and loading of the container. The container is locked to secure the contents and prevent theft of materials. When the contents of the container are needed, the container may be again lifted by a fork lift or other device and moved to an appropriate location. The container is then unlocked and the top cover removed. At least one of the side panels is also removed to facilitate unloading of the contents of the container. After the contents of the container are unloaded, the container may be returned or the container may be used to store debris or other waste from the construction site. If debris and waste are to be loaded, the top cover and the at least one removable side panel may remain disassembled to facilitate loading of the debris and waste. Once loading is complete, the top cover and at least one removable side panel are reassembled with the fixed structure of the container to fully enclose the debris or other waste. The container may then be retrieved by a disposal company or the original retailer and the contents disposed of according to applicable disposal regulations. When the contents of the container are unloaded for disposal, the container may simply be inverted so that the contents can be quickly displaced. While inverted, the weight of the fully loaded container is supported by the lift pockets. Once emptied, the container may then be cleaned and prepared for subsequent use.

The use of the dual service reusable container for shipping goods to a retailer is a further embodiment. A container of goods is ordered and shipped to a retailer. The dual service reusable containers may be shipped on various types of trucks and trailers or other common shipment methods. During shipment, the container may be stacked on top of other dual service reusable containers containing goods so that shipping efficiency can be improved. The dual service reusable containers occupy substantially all of the available space of a standard shipping method, improving shipping efficiency. When the container arrives at the destination, the retailer may store the container in an unprotected area that is exposed to the weather until the contents of the container are needed because the contents are protected from the elements by the container. The container may be delivered to the retailer unattended because the contents are locked and secured. The retailer may stack the loaded containers to minimize the floor space consumed by the containers. If stacked, the containers may be separated by load bars so that containers loaded to the maximum design weight can be securely stacked. The containers may remain locked and secured to prevent theft of the contents contained within. When the contents of the container are needed, the container may be lifted by a fork lift or other device and moved to an appropriate location. The container may then be unlocked and the top cover removed. The least one removable side panel may also be removed to facilitate unloading of the contents of the container. After the contents of the container are unloaded, the container may be returned or the container may be used to store other goods for subsequent shipment. The container may also be nested with other dual service reusable containers so that valuable floor space is not used to store the unloaded, or partially loaded, dual service reusable containers. The container may be cleaned and prepared for subsequent use. Once the container is loaded, the top cover and the at least one removable side panel and end panel may be assembled with the remaining portions of the container to fully enclose the contents of the container. The container may then be retrieved and shipped to its next destination.

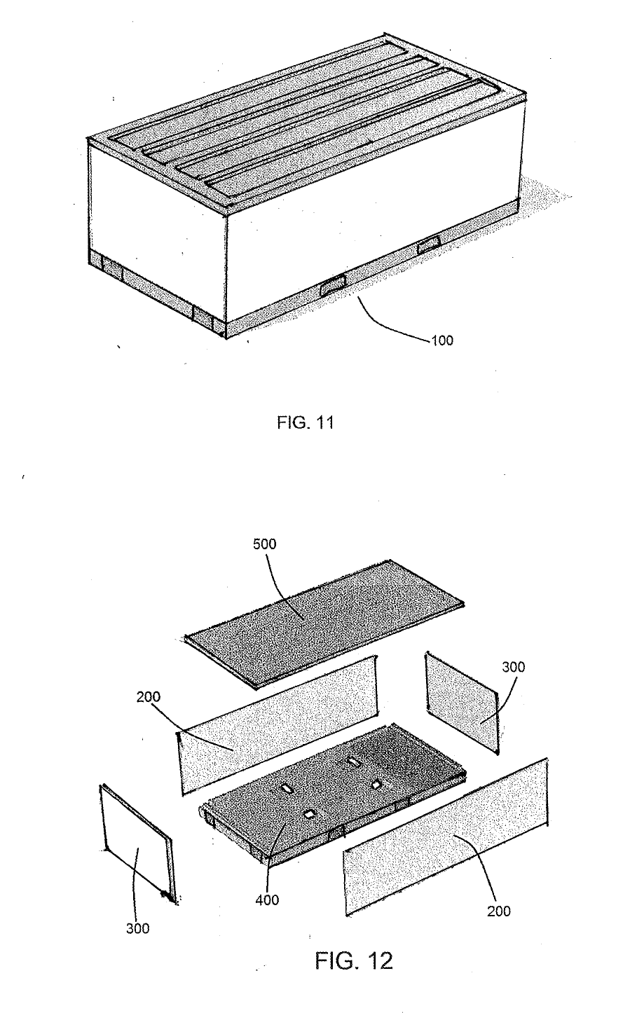

One additional embodiment of the present dual service reusable container will be described. Features of this embodiment can be combined with features of above embodiments. Like the above described embodiments, the container 100 includes a container body formed by two side panels 200, two end panels 300, and a bottom panel 400. The container, as assembled, is illustrated in FIGS. 11 and 12. At least one side panel 200 is removable. The panels cooperate to form the container body and define an interior container volume and an open container top. A removable top cover 500 can be attached to cover the container body and seal the interior container volume. This embodiment of the dual service reusable container may also includes corner posts 700 which will be described in detail later.

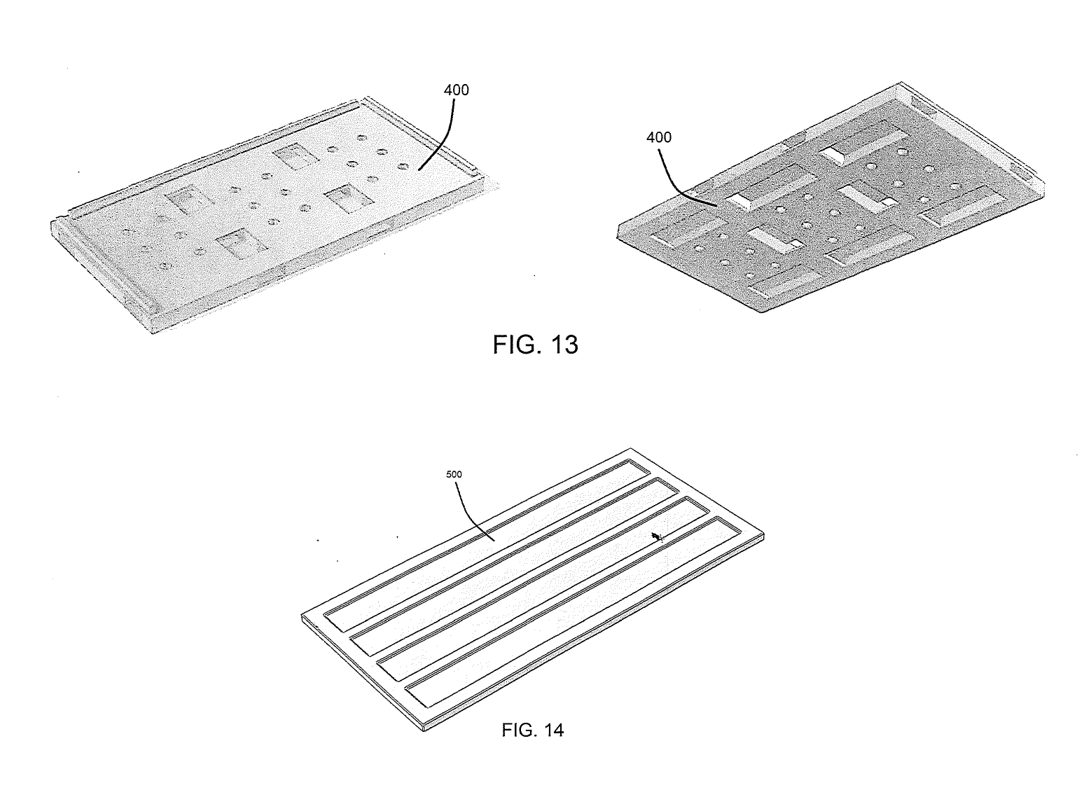

FIG. 13 illustrates the bottom panel 400 of this embodiment of the dual service reusable container 100. The bottom panel 400 in this embodiment may be rotationally molded. The bottom panel 400 includes a lip that is parallel to the outer edge of the bottom panel 400 and serves as a tongue to help stabilize the two side panels 200 and the two end panels 300. A replaceable floor may be added to the bottom panel 400 to reinforce the floor and to provide a surface that helps reduce the amount of movement of the material contained within the container 100. The replaceable floor may be formed of any suitable material and may also have additional properties including shock absorption, sound absorption, and other useful properties. The bottom panel may also include pockets configured to receive corner post 700 which will be described later.

FIG. 14 illustrates the top cover 500 of this embodiment of the dual service reusable container 100. The top cover 500 may be rotationally molded or vacuum formed. For example, the top cover 500 may be made of vacuum formed polyethylene. The top cover 500 is configured to help make the container 100 water resistant. The top cover 500 is lockable by a single lock or a plurality of locks. The top cover also includes identifying indicia such as a bar code, a label, or other identifying information.

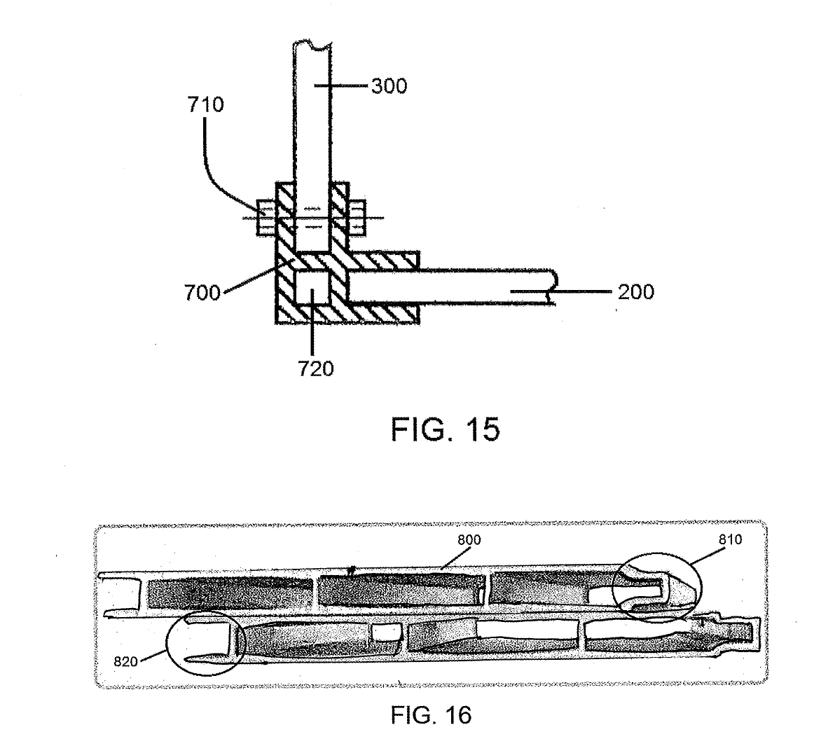

The corner post 700 may be secured to any and/or all four corners of container 100. A cross section of a corner post 700 is illustrated in FIG. 15. A corner post 700 may be welded to the bottom panel 400 or otherwise affixed to the bottom panel 400, for example, at each corner of the bottom panel 400. The corner post 700 extends vertically away from the bottom panel 400. The corner post 700 includes notches and other features that allow the corner post 700 to receive a side panel 200 and an end panel 300. For example FIG. 15 illustrates a corner post 700 including recesses that correspond to the width of the two side panels 200 and the two end panels 300. The corner post 700 receives ends of the panels to form the container 100. The corner post 700 may also include a fixing device 710 to secure the panels to the corner post 700. The fixing device 710 may be a bolt and a lock nut, or any other means known to those of skill in the art. The panels may be secured in a removable manner to the corner post 700 or the panels may be secured to the corner post 700 in a permanent manner.

The corner post 700 is particularly suitable when one of the panels being secured is a removable panel, and when one of the panels is an interlocking panel, to be discussed later. As discussed above, at least one of the two side panels 200 and the two end panels 300 is removable. The removable panel may have dimensions that are slightly different from the non-removable panels so that the removable panel may be easily added to and removed from the container. For example, the thickness of the ends of the removable panel may be slightly thinner to facilitate removal of the panel. Another modification including changing the recesses of the corner post 700 to be slightly wider so that removal of the removable panel is facilitated. When the corner post 700 is used with a removable panel, the height of the corner posts 700 at the ends of the removable panel may be different from the other corner post 700 so that a removable channel 750 may be accommodated and an even surface for the top cover 500 is provided.

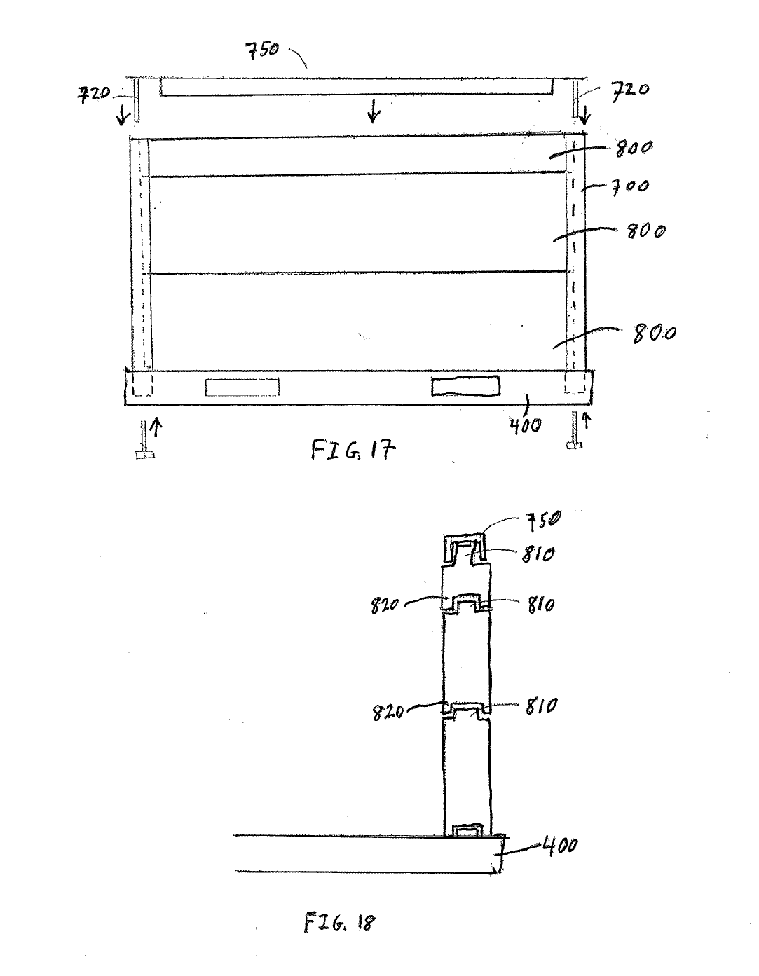

The two side panels 200, the two end panels 300, and the top cover 500 may be formed of multiple interlocking panels 800. One example of such a type of panel is illustrated in FIG. 16. Each interlocking panel 800 includes a tongue portion 810 and a recess portion 820. The tongue portion 810 is received in the recess portion 820 in a secure manner so that the interlocking panels 800 form a single panel. The interlocking panels 800 may include an additional securing device to ensure that the interlocking panels 800 remain affixed to each other. The interlocking panels 800 may be made of any suitable material and may be hollow or solid or may include internal structures that help improve the rigidity of the interlocking panels 800. Each portion 800 need not be made of the same materials. For example, in one embodiment the topmost portion 800 may be formed of aluminum or another highly resilient and lightweight material to provide additional structural rigidity. In this embodiment, the lower portions 800 may be made of fiberglass or another lightweight material that need not have the same rigidity as the topmost portion.

The corner post 700 may also include a reinforcing structure 720 to help provide additional structural support for the container 100. The reinforcing structure 720 may be made of any material suitable for adding structural support for the container 100. As shown in FIG. 15, the reinforcing structure may be positioned at the intersection of the planes defined by the side panel 200 and the end panel 300 inserted into the corner post 700. Other arrangements of the reinforcing structure 720 are contemplated by this disclosure including offsetting the reinforcing structure 720 from at least one of the planes of the side panel 200 and the end panel 300. The corner post 700 may be made of steel or another resilient and lightweight material.

One example of the reinforcing structure 720 is illustrated in FIG. 16. A removable channel 750 includes two reinforcing structures 720 at each end. The reinforcing structures 720 extend downward into the corner post 700 to provide additional rigidity to the container 100. The reinforcing structures 720 extend downward towards the bottom panel 400 for a distance that helps secure the portions 800 of the removable panel.

FIG. 17 illustrates one example of how the corner post 700 cooperates with a removable channel 750 to secure the removable side wall. FIG. 16 illustrates three portions 800 of the removable side wall that are stacked vertically. Each of the portions 800 are inserted into the corner post. After the topmost portion 800 has been positioned, a removable channel 750 is placed on top of the topmost portion 800 so that the portions 800 are secured to form a single panel. After the removable channel 750 has been placed on top of the corner posts 700 that are positioned at the ends of the removable panel, the top cover 500 may be secured to the top of the container 100.

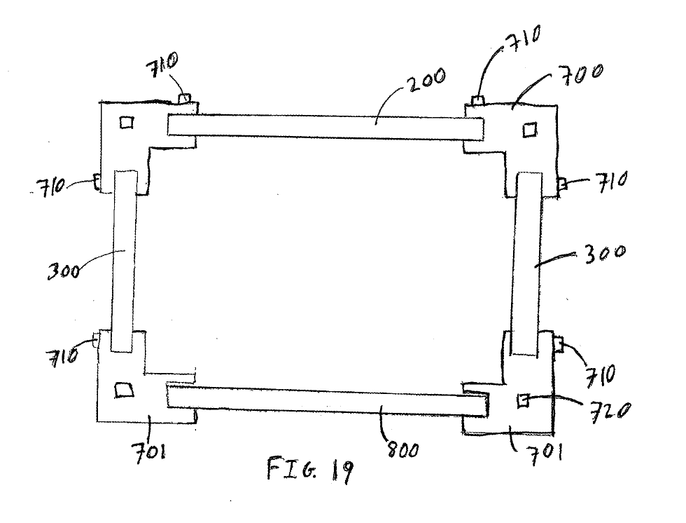

FIG. 18 illustrates a cross-section of the different portions 800 and the channel 750 that form a panel. Each panel 800 includes a tongue portion 810 and a recess portion 820. The recess portion 820 receives the tongue portion 810. The removable channel 750 is positioned on the tongue portion 810 of the topmost portion 800.

FIG. 19 illustrates a top view of the panels and the corner posts. The end panels 300 and the side panel 200 are secured by a fixing device 710 to the corner post 700 so that the side panels 200 and the end panels 300 are fixed to the corner posts 700. The removable panel 800 is not, however, secured by the fixing device 710. This allows for the removable panel 800 to be easily removed so that the contents of the container 100 may be removed or so that items can be placed within the container 100. Additionally, FIG. 19 illustrates how the recess of the corner posts 701 is slightly larger than the width of the portions 800 so that the portions 800 may be easily removed.

Example dimensions of the modified dual service reusable container are provided. The bottom panel 400 may be from 7′9″ to 8′8″ long and from 47″ to 54″ wide with a thickness of 3″ to 8″. The lip formed parallel to the outer edge is from 0.3″ to 0.7″ wide and 0.3″ to 0.7″ thick and is approximately 0.5″ to 1″ inward from the outer edge of the bottom panel 400. The replaceable floor may be from 0.4″ to 1″ thick. The top cover 500 has similar dimensions to the bottom panel 400 so that a uniformly sized container 100 is formed.

Techniques consistent with the present disclosure provide, among other features, a dual service reusable container and a method of using the dual service reusable containers. While various embodiments of the disclosed dual service reusable container and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A container useful as a dual service reusable container, the container comprising:
a bottom panel;
a top cover disposed substantially parallel to the bottom panel;
a first side panel disposed between a first transverse side of the bottom panel and a first transverse side of the top cover;
a second side panel disposed between a second transverse side of the bottom panel and a first transverse side of the top cover;
a first end panel disposed between a first longitudinal side of the bottom panel and a first longitudinal side of the top cover; and
a second end panel disposed between a second longitudinal side of the bottom panel and a second longitudinal side of the top cover;
wherein the two end panels, the two side panels, the bottom panel, and the top cover define a container body that includes an interior volume of the container;
wherein the two end panels and the bottom panel are joined to form a fixed structure;
wherein the top cover is removable from the fixed structure to facilitate loading or unloading of the container,
wherein at least one of the side panels is removable from the fixed structure to facilitate loading or unloading of the container,
wherein the bottom panel comprises at least two adjacent lift pockets on at least one transverse side and at least two adjacent lift pockets on at least one longitudinal side.

2. The container of claim 1, wherein each of the first and the second transverse sides of the bottom panel comprise at least two lift pockets.

3. The container of claim 2, wherein each of the first and the second longitudinal sides of the bottom panel comprise at least two lift pockets.

4. The container of claim 1, wherein the lift pockets are integrally formed with the bottom panel.

5. The container of claim 1, wherein the lift pockets are configured so that the weight of the container can be fully supported by two lift pockets on a side when the container is inverted.

6. The container of claim 1, wherein corner posts are secured to the bottom panel to provide structural support, the corner posts each receiving at least one end panel and at least one side panel.

7. The container of claim 6, wherein the corner posts are configured to allow at least one panel to be removed while securing the remaining panels in a fixed manner.

8. The container of claim 1, wherein the side panels and the end panels are formed of interlocking panels, each interlocking panel having a tongue portion configured to fit with a receiving portion of an adjacent interlocking panel.

9. The container of claim 1, wherein the interior volume of the container can be secured by a single lock.

10. The container of claim 1, wherein the interior volume of the container is secure from the environment and is substantially water-tight.

11. A method of delivering goods to a location using the container of claim 1, the method comprising:
a delivery provider delivering the container containing items from a sender sending location to a recipient receiving location;
the recipient removing items from the container;
the delivery provider delivering the container from a recipient sending location to a sender receiving location.

12. The method of claim 11, further comprising:
the recipient removing the items from the container;
the recipient loading other items into the container;
the delivery provider delivering the container to a third receiving location before delivering the container to the sender receiving location;
a third receiver, at the third receiving location, unloading the other items from the container;
the delivery provider, after the third receiver has unloaded the other items from the container; delivering the container from a third sending location to the sender receiving location.

13. The method of claim 11, wherein the container is stacked on top of at least one similar container when the container is at a sending location, a receiving location, or when the container is being delivered by the delivery provider using standard shipping methods.

14. The method of claim 13, wherein the container stacked on top of at least one similar container is at the maximum design weight.
